(19) United States
(12) Patent Application Publication
(10) Pub. No.: US 2024/0056730 A1
(43) Pub. Date: Feb. 15, 2024

(54) Ceiling Tile Microphone Array Enclosure

(71) Applicant: ClearOne, Inc., Salt Lake City, UT (US)

(72) Inventors: Derek Louis Graham, South Jordan, UT (US); Pichet Ong, West Jordan, UT (US); William Deberard, Brighton, CO (US); Feng (Alan) Zhao, Tanzhou Town (CN)

(21) Appl. No.: 18/230,886

(22) Filed: Aug. 7, 2023

Related U.S. Application Data
(60) Provisional application No. 63/396,698, filed on Aug. 10, 2022.

(51) Int. Cl. H04R 1/40; H04R 1/08

(52) U.S. Cl. CPC H04R 1/406; H04R 1/083; H04R 2201/021; H04R 2201/401

(57) ABSTRACT

A ceiling-mounted microphone array enclosure includes a room panel and a top panel. The room panel includes a border of solid material that surrounds a central sound permeable area having sound permeable perforations. The top panel is connected to the room panel through connectors arranged along the border of solid material. The top panel can have sides and be connected to the room panel such that there is a gap to permit improved airflow, or sides of the top panel can connect directly to the bottom panel without a gap. A microphone array and other electronic components can be arranged within the enclosure and then ceiling mounted within a ceiling grid. Multiple differently sized room panels can be manufactured in such a way that they can connect directly to the top panel. To reduce manufacturing costs, each of the top panels can be manufactured having the same size and design.

### PRIORITY CLAIM

This application is a non-provisional of and claims priority from U.S. Provisional Patent Application Ser. No. 63/396,698, filed Aug. 10, 2022, the contents of which are incorporated herein by reference in their entirety.

### TECHNICAL FIELD

This disclosure relates generally to ceiling-tile-mounted microphone arrays and more specifically to mechanical enclosures and support systems for ceiling-tile-mounted microphone arrays.

### BACKGROUND

Conventional enclosures for ceiling-tile-mounted microphone arrays suffer from several drawbacks. One problem is that some ceiling tile microphone enclosure designs require several parts of the enclosure to be disassembled and removed to facilitate painting of the room-facing panel to match the aesthetics of the room the device will be installed in. In some cases, existing designs require removal of all four sides of the ceiling tile just to remove the room-facing panel. Other existing designs require removal of the room-facing panel along with an internal framework that provides mechanical rigidity for the room-facing panel. This type of design may require the framework to be masked with tape prior to painting, so that paint is only applied to the room panel, and not the frame. The masking step requires extra time and makes it more difficult to use processes like electro-plating or powder coating to paint only the room-facing panel of the tile and not the frame.

Another problem is that drop ceiling grids typically have 24-inch grid spacing in the United States and 600 mm or 625 mm spacing in Europe and Asia. Current ceiling tile enclosure designs require completely different mechanical components for each different type of grid spacing in order to properly fit the ceiling grid spacing.

One example of a known ceiling-tile-mounted microphone array is described in U.S. Pat. No. 9,813,806, commonly owned by the applicant/assignee, the entire disclosure of which is incorporated by reference herein.

### SUMMARY OF THE DISCLOSURE

According to one embodiment, a ceiling mountable microphone array system enclosure comprises a room-facing panel and a top panel. The room-facing panel comprises a border of solid material arranged around a sound-permeable area and a plurality of connection members arranged along the border of solid material of the room-facing panel. The top panel provides a cover for the enclosure and comprises a plurality of connection points to enable connections with the plurality of connection members of the room-facing panel. A plurality of microphone array system electronic components can be arranged within the microphone array system enclosure between the room panel and the top panel. The plurality of electronic components can, for example, comprise a microphone array arranged in proximity to the sound permeable area.

Optionally, according to one embodiment, the plurality of connection members are arranged along an upper side of the border of solid material. The plurality of connection points arranged on the top panel and/or the plurality of connection members may comprise one or more standoffs, which support the top panel in such a way that the top panel does not directly contact the room-facing panel other than at the standoffs.

Optionally, according to one embodiment, the standoffs are threaded standoffs, and the connection points or connection members in the opposing one of the top panel or room-facing panel comprise screw holes arranged to communicate with the threaded standoffs to permit screws to be inserted therethrough to connect the top panel to the room-facing panel.

Optionally, according to one embodiment, the connection members and connection points comprise eight threaded standoffs and eight screw holes.

Optionally, according to one embodiment, the system further comprises one or more stiffeners configured to connect to the top panel and connect to support wires arranged between the stiffeners and a structural ceiling.

Optionally, according to one embodiment, the connection members on the room-facing panel comprise snap fit connectors configured to snap into or onto the connection points on the top panel.

Optionally, according to an alternative embodiment, the room-facing panel is connected directly to a side of the top panel. A flange along one or more sides of the top panel can include connection points (such as holes for receiving screws or other attachment mechanisms) that connect with connection members (such as matching holes) arranged in the room-facing panel. Other connection mechanisms, such as snap-fit or tongue-in-groove connections, for example, could be used to connect the side of the top panel directly to the room-facing panel.

Optionally, according to one embodiment, the top panel further comprises an opening and connection points configured to receive and connect to a main board comprising electronic components of the microphone array system, and the enclosure further comprises an IO panel configured to connect to the top panel and cover the main board.

Optionally, according to one embodiment, the IO panel comprises one or more openings arranged through a top or side of the IO panel and configured to expose connector ports arranged on the main board.

Optionally, according to one embodiment, the top panel comprises one or more sides bent downward from the upper member of top panel to provide sides to the enclosure.

Optionally, according to an alternative embodiment, flanges extend substantially horizontally from one or more of the sides to lay substantially flat against the border of the room-facing panel.

Optionally, according to another embodiment, a connection between the top panel and the room-facing panel leaves a gap between the sides of the top panel and the room-facing panel that permits airflow into and out of the enclosure.

Optionally, according to one embodiment, the sound-permeable area comprises a plurality of sound-permeable perforations.

Optionally, according to some embodiments, the sound-permeable area has a rectangular, square, or circular shape.

Optionally, according to one embodiment, the plurality of electronic components further comprises processing circuitry arranged in communication with the microphone array.

According to another embodiment, an enclosure for a ceiling-mountable microphone array system comprises a top panel, a room panel, and a plurality of connection members. The top panel has a substantially flat upper panel with one or more sides bent downward from the upper panel to form sides for the enclosure. The room panel comprises a substantially flat bottom panel with a number of sound permeable perforations arranged in a central area of the bottom panel and a border of solid material arranged around an outside perimeter of the bottom panel. The plurality of connection members are arranged on the top panel, the bottom panel, or both.

According to one embodiment, the connection members are configured to support and connect the top panel to the bottom panel in a manner such that the sides of the top panel do not contact the bottom panel, thereby leaving a gap for airflow between the top and bottom panels.

Optionally, according to an alternative embodiment, one or more flanges along one or more of the sides of the top panel lay substantially flat against and connect directly to the room panel along the border.

Optionally, according to another embodiment, the connection members comprise standoffs.

Optionally, according to one embodiment, the standoffs are threaded standoffs and are configured to receive screws through screw holes arranged in an opposing one of the top or bottom panel to connect the top panel to the bottom panel.

Optionally, according to one embodiment, the standoffs comprise snap-fit connectors configured to connect with corresponding connection features in the opposing one of the top or bottom panel.

Optionally, according to one embodiment, the system further comprises an IO panel configured to connect to the top panel and cover a main board of the microphone array system, wherein the IO panel comprises one or more openings configured to expose electronic connectors arranged on the main board.

### BRIEF DESCRIPTION OF THE DRAWINGS

FIG. 1 is a somewhat schematic exploded isometric view of a ceiling tile microphone array enclosure including a mechanical enclosure for enabling installation of the microphone array as a ceiling tile and electronic components of a beamforming microphone array system.

FIG. 2 is a somewhat schematic top and bottom isometric view of the assembled ceiling tile microphone array enclosure of FIG. 1.

FIG. 3 is a somewhat schematic top isometric view of a ceiling tile microphone array enclosure according to an alternative embodiment, similar to that of FIG. 1, without the stiffeners and having a centrally arranged IO enclosure.

FIG. 4 is a somewhat schematic exploded isometric view of the ceiling tile microphone array enclosure of FIG. 3.

FIG. 5 provides somewhat schematic top and side views of the top panel of the ceiling tile microphone array enclosure of FIG. 1.

FIG. 6 provides somewhat schematic top and bottom isometric views of the top panel of the ceiling tile microphone array enclosure of FIG. 1.

FIG. 7 provides various top, bottom, and side views of the room panel of the ceiling tile microphone array enclosure of FIG. 1.

FIG. 8 provides a somewhat schematic top isometric view of the room panel of the ceiling tile microphone array enclosure of FIG. 1.

FIG. 9 provides a somewhat schematic side and isometric view of the stiffener of the ceiling tile microphone array enclosure of FIG. 1.

FIG. 10 provides somewhat schematic top views of a felt liner and foam windscreen that can be sandwiched between the top and room panels of the ceiling tile microphone array enclosure of FIGS. 1 and 3.

FIG. 11 provides somewhat schematic top and side views of the top panel of the ceiling tile microphone array enclosure of FIG. 3.

FIG. 12 provides somewhat schematic top and bottom isometric views of the top panel of the ceiling tile microphone array enclosure of FIG. 3.

FIG. 13 is somewhat schematic top and isometric view of the top panel of the ceiling tile microphone array enclosure of FIG. 1 to compare with the top panel of FIG. 12.

FIG. 14 provides multiple views of a room panel of the ceiling tile microphone array enclosure of FIG. 1 or 3.

FIG. 15A is a somewhat schematic top plan view of a room panel of the ceiling tile microphone array enclosure of FIG. 1 or 3, wherein the room panel is sized to fit a 625 mm spaced ceiling grid and configured to readily attach to the top panel.

FIG. 15B is a somewhat schematic top plan view of a room panel of the ceiling tile microphone array enclosure of FIG. 1 or 3, wherein the room panel is sized to fit a 600 mm spaced ceiling grid and configured to readily attach to the top panel.

FIG. 15C is a somewhat schematic top plan view of a room panel of the ceiling tile microphone array enclosure of FIG. 1 or 3, wherein the room panel is sized to fit a 24-inch spaced ceiling grid and configured to readily attach to the top panel.

FIG. 16 is a somewhat schematic exploded perspective view of a ceiling tile microphone array enclosure according to a still further embodiment of the principles of the present inventive concepts, wherein sides of the top panel connect directly to the bottom panel through screws or other attachment mechanisms.

### DETAILED DESCRIPTION

### Overview

The principles of the present inventive concepts provide an improved mechanical enclosure for a ceiling-tile-mounted microphone array (MA), such as a beamforming microphone array (BMA). The enclosure may consist of several major components, including, for example, a room-facing panel, a top panel, and an input/output (IO) panel. Safety stiffeners may also be provided.

A room-facing panel (or “room panel”) includes a collection or arrangement of perforations designed to allow sounds in the range of human hearing to pass through the room panel with no significant reflection or attenuation (i.e., be “acoustically transparent”) so that those sounds can be picked up by an array of microphones mounted within the ceiling tile and behind the room-facing panel. The room panel may also include openings for LEDs, LED lenses, or LED light pipes that may be different in size and shape from the acoustic perforations. The room panel may also have one or more openings for a reset button and/or other buttons, switches, or connections that allow various desired communications or interactions with equipment and operators within the room (i.e., turn on/off, monitor status, mute microphones, connect to recording or broadcasting equipment, etc.).

The room panel may, for example, be made of metal, plastic, carbon fiber, or any other material that has sufficient structural strength to bear the weight of the enclosure and included electronics in all desired mounting configurations without deforming. In one embodiment, the room panel is made of steel or aluminum or a combination thereof.

In one embodiment, the perforations in the room panel do not cover the entire surface of the room panel. Instead, a border of solid material is provided so that the dimensions of the perforation pattern are smaller than the outer dimensions of the room panel. The pattern of perforations may be square, rectangular, circular, hexagonal, or any other shape.

Threaded standoffs or other connection mechanisms can be press-mounted, welded, glued, or otherwise secured or arranged, at various points along the border of solid material. In one embodiment illustrated below, for example, eight standoffs (two on each side) are provided and are press-mounted to the room panel. In one embodiment, the threaded standoffs extend from the room panel through the body of the ceiling tile to a top panel of the ceiling tile that rests on the tops of the threaded standoffs when assembled. Examples of threaded standoffs are PEM® fasteners from Penn Engineering.

In other embodiments, however, the standoffs may be mounted to the top panel and extend to the room panel. Furthermore, the standoffs can provide connection types other than a threaded connection, or connection methods other than standoffs could be used. For example, snap or press-fit connections can be provided between the standoffs and corresponding connectors in the top panel or room panel. Alternatively, connections between the top panel wall and the room panel could be provided without standoffs, such as by matching holes arranged in the top and room panels.

For example, in alternative embodiments, a connection may be made between connectors arranged on the sides of the top panel and mating connectors on the room panel. In one such embodiment, one or more flanges extend substantially horizontally from one or more of the sides of the top panel to lay substantially flat against the border of the room panel. Matching holes can be provided in the flanges and the room panel to receive screws or other connection mechanisms that attach the sides of the top panel directly to the room panel.

In other embodiments, snap or press-fit connections between the sides of the top panel and connectors on the room panel could be provided. Lip-and-groove connectors could also be provided to secure one end of the top panel to the room panel in a hinge-like relationship with the other end of the top panel snap, press, or otherwise fitting into communication with a receiving connector or latch on the room panel. Any other desired mechanical or adhesive connection between the top panel and the room panel could be provided, but preferably provides a readily removable connection between the top panel and room panel to facilitate disassembly between the room panel and the remaining enclosure components to allow painting, electro-plating, or other processes to be performed on the room panel to match the room décor.

The principles of the present inventive concepts significantly decrease the number of screws (or other connection mechanisms) used to secure the room panel to the rest of the assembly, making it much faster to remove the room panel to facilitate painting it to match the color of the room it will be installed in.

In one embodiment, the top panel of the mechanical enclosure is cut and then bent downward along the edges to form sides of the ceiling tile BMA enclosure. For example, small squares can be cut from each of the corners to permit the edges to be bent downward to form sides. In one embodiment, the main body of the top panel rests on standoffs mounted to the room panel. Screw holes are positioned along the main body of the top panel to communicate with the standoffs and allow screws to thread into the standoffs and secure the top panel directly to the standoffs of the room panel. In some embodiments, the sides of the top panel may be shorter than the standoffs to provide an intentional gap between the sides of the top panel and the room panel. This can allow for improved air circulation and cooling within the enclosure. According to these aspects, the room panel may connect directly to the top panel without engaging the sides of the enclosure formed from the top panel.

In an alternative embodiment, the sides of the top panel can connect to the room panel. For instance, one or more sides of the top panel can include flanges that lay substantially flat against the border of the room panel. Screws or other attachment mechanisms can be used to secure the top panel to the room panel through matching holes in the flanges and room panel.

Although the sides can help provide rigidity and strength to the top panel, in still other embodiments, the top panel need not have sides and could simply be a flat or substantially flat panel. As mentioned above, in other embodiments other mechanical connections between the top panel and the room panel may be provided.

The top panel can also provide mounting locations for an electronics module comprising a main board and IO cover or panel. The IO cover or panel can be arranged over an opening in the center or towards a side of the top panel (or any other desired location). The electronics module can include connection holes arranged through a side (or top) of the IO panel for facilitating electrical connections between external cables and connectors on the main board. The connectors can, for instance, enable connection between cables that carry audio data, control data, and power with the electronic components of the ceiling tile beamforming microphone array system arranged (at least in part) on the main board. The connectors may, for instance, include one or more USB ports, Ethernet ports, power connectors, audio connectors, and/or any other desired electronic connectors mounted on the main board.

The top panel may also provide mounting locations for stiffener rails that can be used to cable-mount the enclosure to structural supports. Holes arranged in a base of the stiffener can receive screws or other connectors for connecting the stiffener to the top panel. Holes arranged in sides of the stiffeners can receive cables or connectors that connect to cables to connect the stiffeners to the structural ceiling of the room. Alternatively, the stiffeners may be used to engage seismic safety cables that further connect to the structural ceiling of the room as a supplemental safety feature when the ceiling tile is flush mounted in a suspended ceiling.

Drop ceiling grids typically have 24-inch grid spacing in the United States and 600 mm or 625 mm spacing in Europe and Asia. While conventional designs have required multiple mechanical components to be sized differently to accommodate the different grid spacings, according to further principles of the present inventive concepts, a top panel may be sized and shaped so as to be common to all of the various ceiling tile versions. Using this unique design, only the room panel size needs to be modified to accommodate the different drop ceiling grid spacings. For example, room panels for larger ceiling grids could have a wider border of solid material with the standoffs (or other connectors) arranged further from the edges. Room panels for smaller ceiling grids would have narrower borders of solid material with the standoffs or other connectors arranged closer to the edges. Each of the room panels would have the standoffs or other connectors arranged in a position to communicate with corresponding connection features of the top panel so that regardless of which room panel was selected, the top panel could readily connect to the room panel. In this way, a single type and configuration of top panel would be usable in connection with any of the variously-sized room panels, thus reducing the number of different types of top panels required.

Numerous advantages can be obtained through these inventive principles. Some commercial advantages of the present inventive concepts include lower manufacturing costs and lower implementation costs to match color to room aesthetics. For example, this design enables faster assembly and disassembly to facilitate painting (or other aesthetic processes) because of a simpler connection between the room panel and the top panel. In addition, increased sharing of mechanical parts between the differently sized models leads to higher part volumes and lower cost per part compared to prior designs that required multiple parts to be different sizes to fit different ceiling grid spacing. Multiple different sizes of parts resulted in lower volumes for each part and therefore higher parts costs.

### DETAILED DESCRIPTION OF EMBODIMENTS

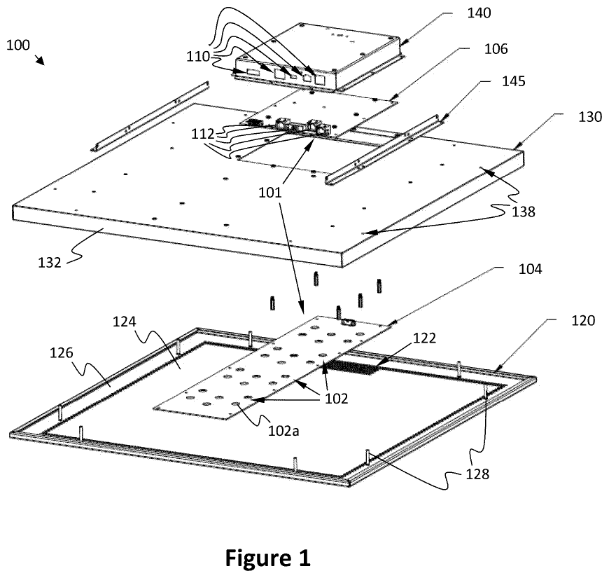

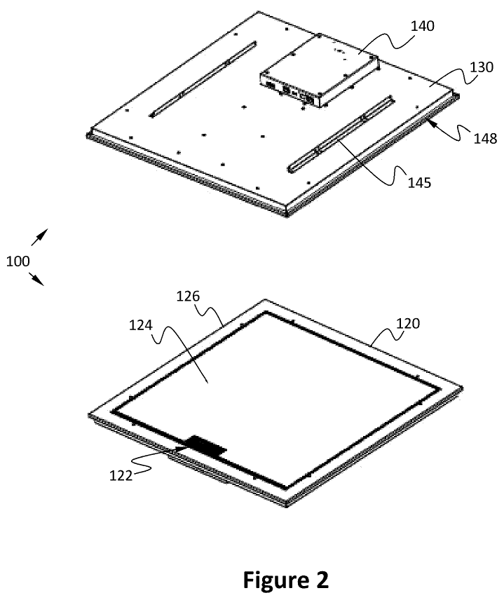

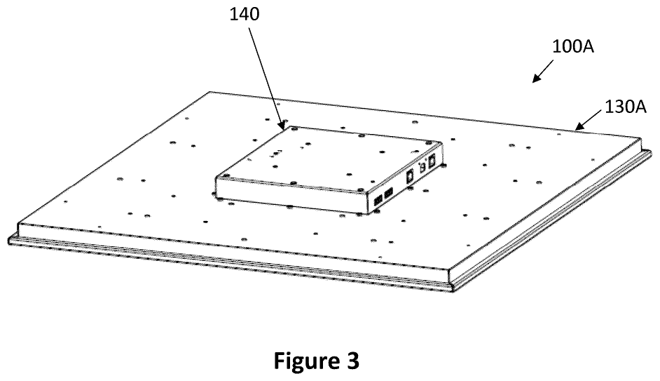

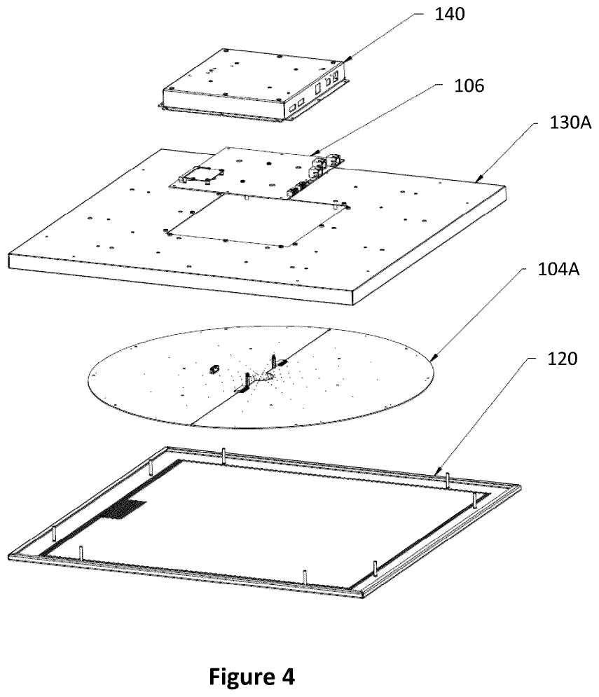

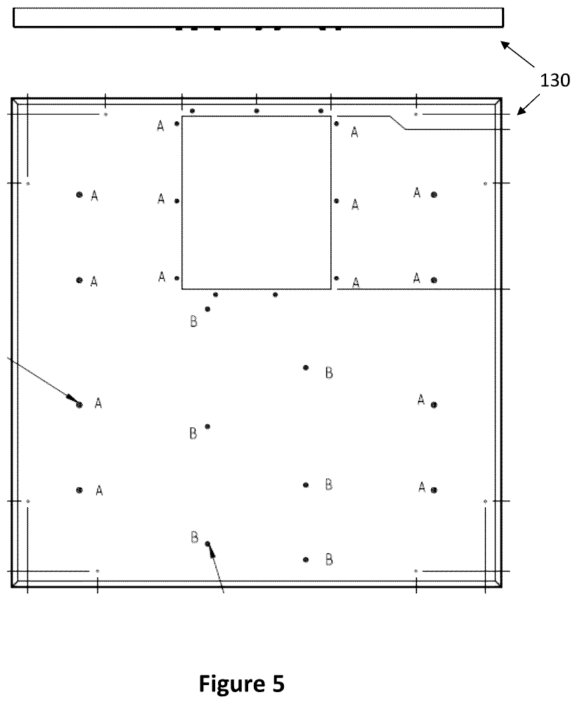

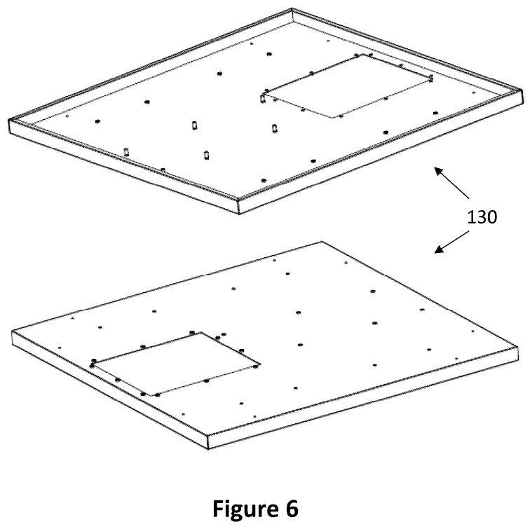

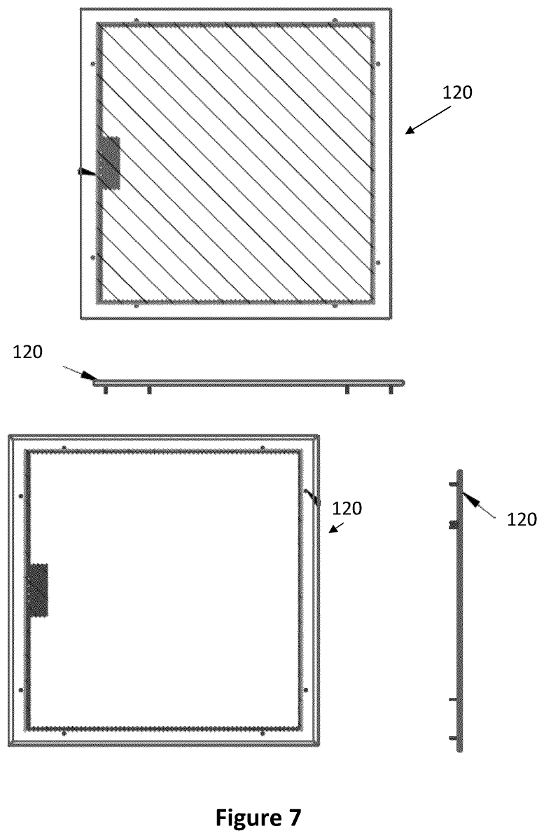

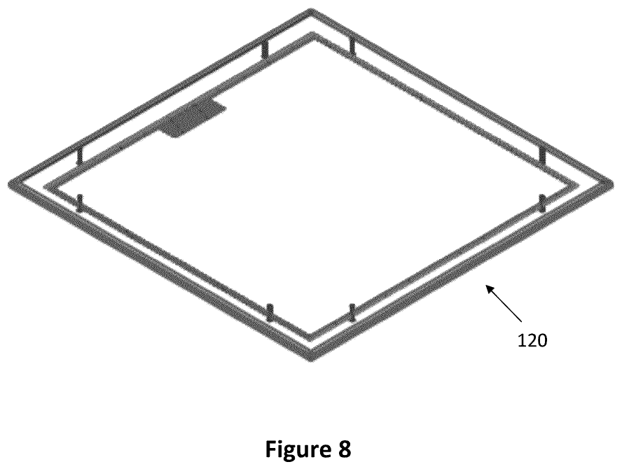

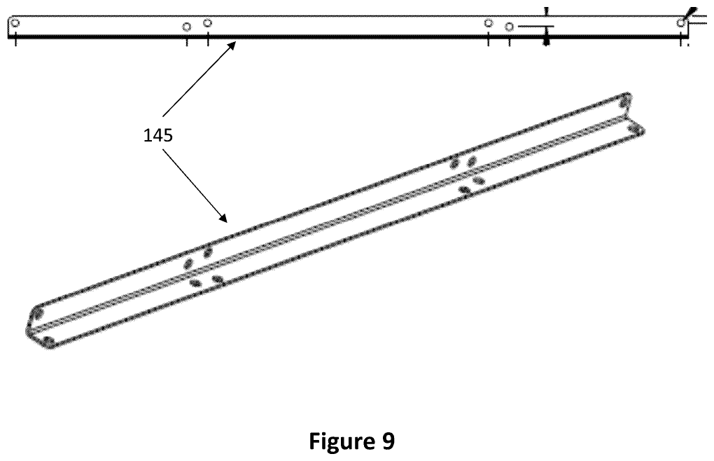

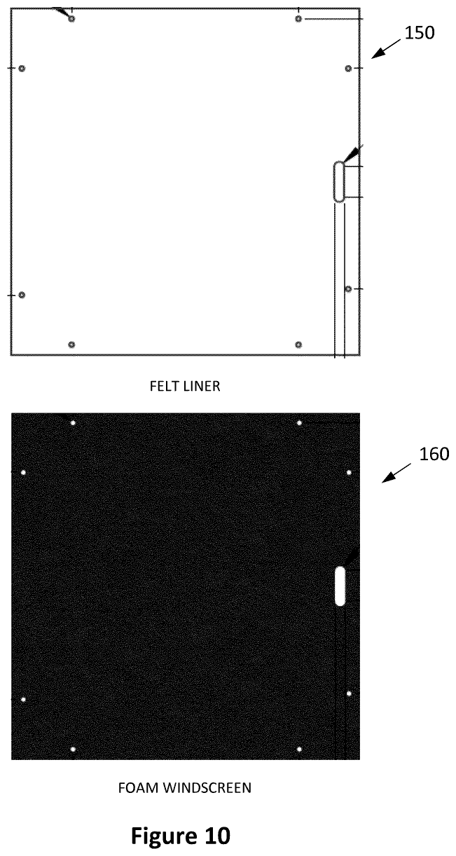

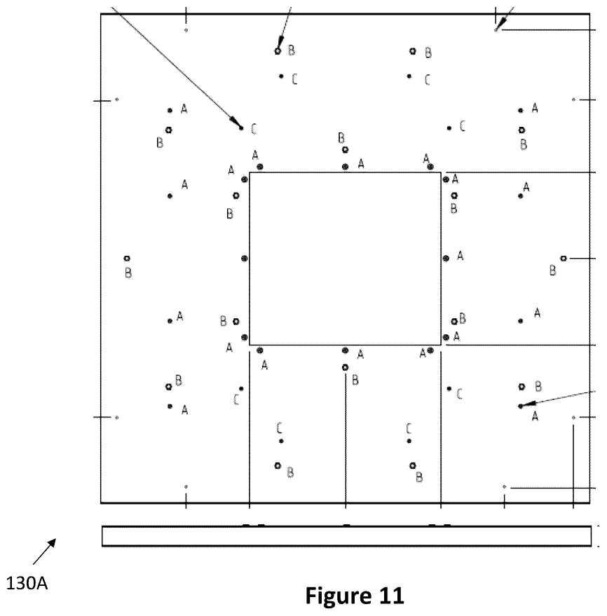

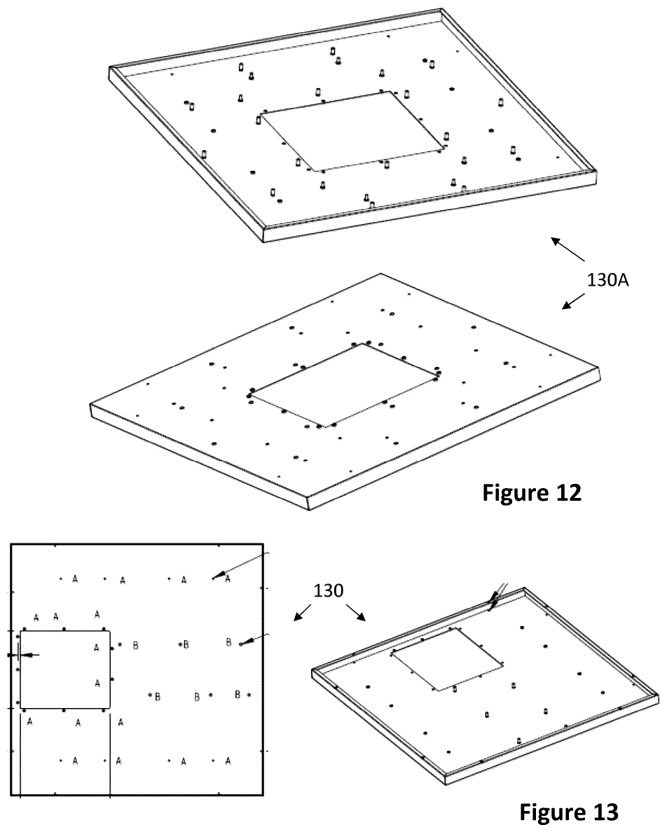

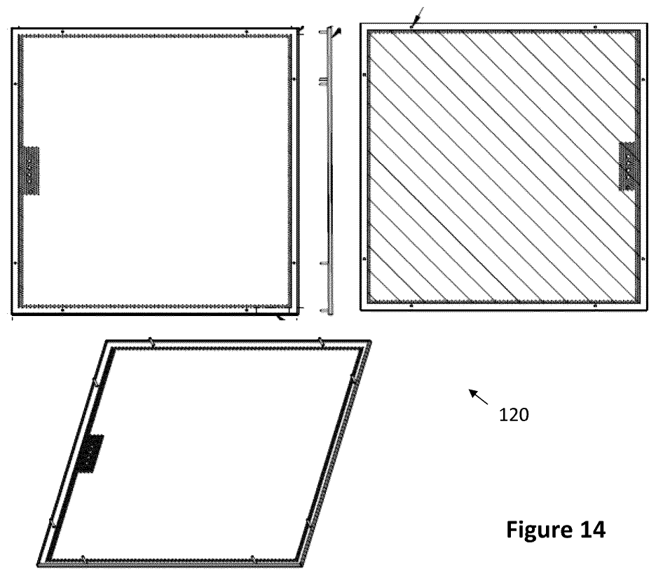

FIG. 1 is a somewhat schematic exploded isometric view of an enclosure 100 for a ceiling mountable microphone system 101 including a microphone array (MA) (which can include a beamforming microphone array (BMA)) 102 arranged on a microphone board 104 and a main board 106 containing electronic components and connectors for processing and communicating the signals received from the MA 102. The electronic components are all arranged within the enclosure 100 having a top panel 130 and a room panel 120. FIG. 2 is a somewhat schematic top and bottom isometric view of the assembled ceiling tile microphone array enclosure 100 of FIG. 1. FIGS. 3 through 16 provide various additional views and alternative embodiments of the array enclosure 100.

As illustrated in FIG. 1, the principles of the present inventive concepts provide an improved mechanical enclosure 100 for a ceiling-tile-mountable microphone system 101. The enclosure 100 may consist of several major components, including, for example, a room panel 120, a top panel 130, and an IO panel 140. Safety stiffeners 145 may also optionally be provided.

Before explaining the mechanical structural components of the enclosure 100, however, a brief, general description of the construction and operation of the ceiling-mountable microphone system 101 will be provided with reference to FIG. 1. In general, a ceiling-mountable microphone system 101 may include a microphone array 102 including multiple microphones 102a configured to transform sound into electrical signals representing multiple audio streams with each stream corresponding to a microphone in the array. The MA 102 may include circuitry and/or audio signal processing configured to receive the electrical signals from the microphones 102a and perform one or more beamforming operations to combine those electrical signals into one or more audio signals. It is also possible for the microphone array board 104 to send signals to the main board 106 so that the main board 106 can perform the beamforming operations. The MA 102 may be configured to generate N audio signals where N is a positive integer. In some embodiments N is one, while in other embodiments N is greater than one. When N equals 1, the number of audio signals may be less or the same as the number of microphones. When N is not equal to 1, the number of audio signals may be greater than, less than, or the same as the number of microphones. Various operations may be performed with respect to a single audio signal or using multiple audio signals.

Each audio signal is associated with a spatial pickup pattern where sound from some directions is attenuated more than other directions. The pickup pattern associated with an audio signal may also be referred to as a beam or beam pattern. A single pickup pattern or multiple pickup patterns may be used. Some of the audio signals may be associated with different pickup patterns while others are associated with the same pickup pattern. The pickup pattern may be fixed, time varying, dynamic, or the like. Some of the audio signals may be associated with fixed pickup patterns while others are associated with dynamic pickup patterns.

The main board 106 circuitry may, for instance, include a general purpose processor, a digital signal processor (DSP), an application specific integrated circuit (ASIC), a microcontroller, a programmable logic device such as a field programmable gate array (FPGA), discrete circuits, a combination of such devices, or the like. Single or multiple processors and/or multiple processor cores may be present. The processor may be coupled to a memory (i.e., any device capable of storing data). Any number of memories and different types of memories may be included. Examples include a dynamic random access memory (DRAM) module, static random access memory (SRAM), non-volatile memory such as Flash, spin-transfer torque magentoresistive random access memory (STT-MRAM), or Phase-Change RAM, magnetic or optical media, or the like.

In some embodiments, the processor and the memory may be part of a single unit, integrated in a single housing, or the like. In other embodiments, the processing, operation, storage, or the like of the processor and the memory may be distributed across multiple components in separate locations linked by various communication interfaces such as analog interfaces, digital interfaces, Ethernet, Fiber Channel, universal serial bus (USB), WiFi, or the like.

The processor may be in the same housing (or even on the same printed circuit board (PCB)) 104 as the MA 102, or it may be arranged in a separate housing. In the embodiment shown in FIG. 1, the MA 102 is arranged on a mic board 104 that is separate from the main board 106 containing the processor (not shown). The enclosure 100 provides support for the electronic components and enables the microphone system 101 to be mounted as a ceiling tile. As noted previously, the enclosure 100 can include several mechanical components that provide the housing and support for the ceiling-tile mountable microphone system 101. These include a room panel 120, a top panel 130, and an IO panel (or cover) 140. Stiffeners 145 may also be provided to add additional safety features.

As shown in FIG. 1, the main board 106 can be mounted on the top panel 130 with a separate IO cover 140 arranged to cover the main board 106 and to protect it from physical damage, dust, and/or other contaminants. Connector port openings 110 are preferably arranged through the IO cover 140 to provide access to the main board 106 connectors 112 and permit power and communication cables to be easily connected to the main board 106. The IO cover 140 can be arranged towards a side of the top panel 120 of the enclosure 100 as shown in FIG. 1, or, as shown in FIG. 3, it can be arranged at or near a center of the top panel 120A of the enclosure 100A.

In other embodiments, the components of the main board 106 could, however, be arranged on the mic board 104 and could be arranged within the top panel 130, without the need for a separate IO panel 140. In this case, connector port openings (not shown) could be arranged through a side 132 of the top panel 130 to enable connection of power and communication cables to connectors on the combination mic board and main board (not shown).

The room-facing panel (or “room panel”) 120 includes a collection or arrangement of perforations 124 designed to allow sounds in the range of human hearing to pass through the room panel 120 with no significant reflection or attenuation. In other words, the perforated area of the room panel 120 is preferably acoustically transparent so that those sounds can be picked up by the array 102 of microphones 102a mounted within the ceiling tile enclosure 100 and behind the room-facing panel 120. The room panel 120 may also include openings 122 for LEDs, LED lenses, or LED light pipes that may be different in size and shape from the acoustic perforations. The room panel 120 may also have one or more additional openings (not shown) for a reset button and/or other buttons, switches, or connections that allow various desired communications or interactions with equipment and operators within the room. These communications and interactions could, for example, include turning the microphone system 101 on/off, monitoring the status of the system 101, muting the microphones 102a, connecting the system 101 to recording or broadcasting equipment, and/or other processes, connections, or interactions.

The room panel 120 may, for example, be made of metal, plastic, carbon fiber, or any other material that has sufficient structural strength to bear the weight of the enclosure 100 and included electronics in the system 101 in all desired mounting configurations without deforming. In one embodiment, the room panel 120 is made of steel or aluminum or a combination thereof.

In one embodiment, the perforation area 124 of the room panel 120 does not cover the entire surface of the room panel 120. Instead, a border 126 of solid material is provided so that the dimensions of the perforation pattern 124 are smaller than the outer dimensions of the room panel 120. The perforation pattern 124 may be any desired shape and size arranged within the border 126 of the room panel 120.

Threaded standoffs 128 or other connection mechanisms can be press-mounted, welded, glued, or otherwise secured or located, at various points along the border 126 of solid material. In this embodiment, eight standoffs (two on each side) 128 are provided and are press-mounted to the room panel 120 along the solid border 126.

In one embodiment, the threaded standoffs 128 extend from the room panel 120 through the body of the ceiling tile enclosure 100 to a top panel 130 of the ceiling tile enclosure 100 that rests on the tops of the threaded standoffs 128 when assembled. Examples of threaded standoffs 128 include PEM® fasteners from Penn Engineering.

In other embodiments, the standoffs 128 may be mounted to the top panel 130 and extend downward to the room panel 120. Furthermore, the standoffs 128 can provide connection types other than a threaded connection, or connection methods other than standoffs 128 could be used. For example, snap or press-fit connections can be provided between the standoffs 128 and corresponding connectors 138 in the top panel 130 or room panel 120. Alternatively, connections directly between the top panel side 132 and the room panel 120 could be provided.

In other embodiments, for example, a connection may be made between connectors (not shown) arranged on the sides 132 of the top panel 130 and mating connectors (not shown) on the room panel 120. Snap or press-fit connections between the sides 132 and connectors on the room panel 120 could be provided, for instance. Lip-and-groove connectors (not shown) could also be provided to secure one end of the top panel 130 to the room panel 120 in a hinge-like relationship with the other end of the top panel 130 snap, press, or otherwise fitting into communication with a receiving connector or latch (not shown) on the room panel 120. Any other desired mechanical or adhesive connection between the top panel 130 and the room panel 120 could be provided, but preferably provides a readily removable connection between the top panel 130 and room panel 120 to facilitate disassembly between the room panel 120 and the remaining enclosure 100 components to allow painting, electro-plating, or other processes to be performed on the room panel 120 to match the room décor.

Principles of the present inventive concepts significantly decrease the number of screws (or other connection mechanisms) used to secure the room panel 120 to the rest of the assembly 100, making it much faster to remove the room panel 120 to facilitate painting it to match the color of the room it will be installed in.

Referring now to FIGS. 1 to 15C, the top panel 130, 130A of the mechanical enclosure 100, 100A can be cut and then bent downward along the edges to form the sides 132 of the ceiling tile BMA enclosure 100, 100A. In these embodiments, the main body 134 of the top panel 130, 130A rests on the standoffs 128 mounted to the room panel 120. Screw holes 138 are positioned along the main body 134 of the top panel 130, 130A to communicate with the standoffs 128 and to allow screws to thread into the standoffs 128 and to secure the top panel 130, 130A directly to the room panel 120.

In some embodiments, the sides 132 of the top panel 130, 130A may be shorter than the standoffs 128 to provide an intentional gap 148 between the sides 132 of the top panel 130, 130A and the room panel 120. This can allow for improved air circulation and cooling within the enclosure 100, 100A. According to these aspects, the room panel 120 may connect to the top panel 130, 130A without engaging the sides 132 of the enclosure 100, 100A formed from the top panel 130, 130A.

Although the sides 132 can help provide rigidity and strength to the top panel 130, in alternative embodiments, the top panel 130 need not have sides and could simply be a flat or substantially flat panel (not shown). Furthermore, other mechanical or adhesive connections between the top panel 130 and the room panel 120 may be provided.

Any desirable mechanical connection members or adhesives could be used to connect the top panel 130 and the room panel 120. For example, a hinge (not shown) could be provided on one side of either the top panel 130 or room panel 120 and a set of metal snap features (not shown) could be provided on the other side. The snaps could be released to open the hinge and closed to secure the panels together. In other configurations, snap features could be provided around the full periphery of both the room panel 120 and the top panel 130 without a hinge member. Alternatively, if the room panel 120 is made from a lightweight material, like plastic, for example, posts (not shown) could be arranged on the top panel 130 that extend to the location of the room panel 120. Velcro pads (not shown) on the posts could secure to matching Velcro pads on the room panel 120, or adhesive could be used to secure the posts to the room panel 120. In still other configurations, slide locks (not shown) could be provided which allow the room panel 120 to be placed close to the top panel 130 and then shifted so that a slide lock feature on the room panel 120 locks into a mating feature on the top panel 130. The slide locks could further include magnetic retention features. In another configuration, a keyhole slot feature (not shown) on one panel could receive and retain a matching post on the other panel. In a yet further configuration, threaded bolts (not shown) could be installed into the room panel 120 that are designed so that the bolts extend all the way through the top panel 130 so they could be attached with bolts or wing nuts (not shown) on an opposite side of the top panel 130. In yet another alternative configuration, smooth bolts (i.e., Clevis pins) (not shown) could extend from the room panel 120 up through the top panel 130 and cotter pins could be pushed through openings in the Clevis pins to secure the room panel 120 to the top panel 130. The Clevis pins could further be spring loaded so that they hold the room panel 120 securely to the top panel 130.

The top panel 130, 130A can also provide mounting locations 136 for an electronics module 142 comprising a main board 106 and IO cover or panel 140. An opening in the top panel 130, 130A covered by the IO panel 140 can be toward a side of the top panel 130 or at or near the center of the top panel 130A. The electronics module 142 can include connection holes 110 arranged through a side (or top) of the IO panel 140 for facilitating electrical connections between external cables (not shown) and connectors 112 on the main board 106. The connectors 112 can, for instance, enable connection between cables that carry audio data, control data, and power with the electronic components of the ceiling-tile-mountable microphone system 101 arranged (at least in part) on the main board 106. The connectors 112 may, for instance, include one or more USB ports, Ethernet ports, power connectors, audio connectors, and/or any other desired electronic connectors mounted on the main board 106.

The top panel 130 may also provide mounting locations for stiffener rails 145 that can be used to cable-mount the enclosure 100 to structural supports (not shown). Holes 146a arranged in a base 146 of the stiffener 145 can receive screws or other connectors for connecting the stiffener 145 to the top panel 130. Holes 147a arranged in sides 147 of the stiffeners 145 can receive cables or connectors that connect to cables (not shown) to connect the stiffeners 145 to the structural ceiling (not shown) of the room. Alternatively, the stiffeners 145 may be used to engage seismic safety cables (not shown) that further connect to the structural ceiling of the room as a supplemental safety feature when the ceiling tile enclosure 100 is flush mounted in a suspended ceiling.

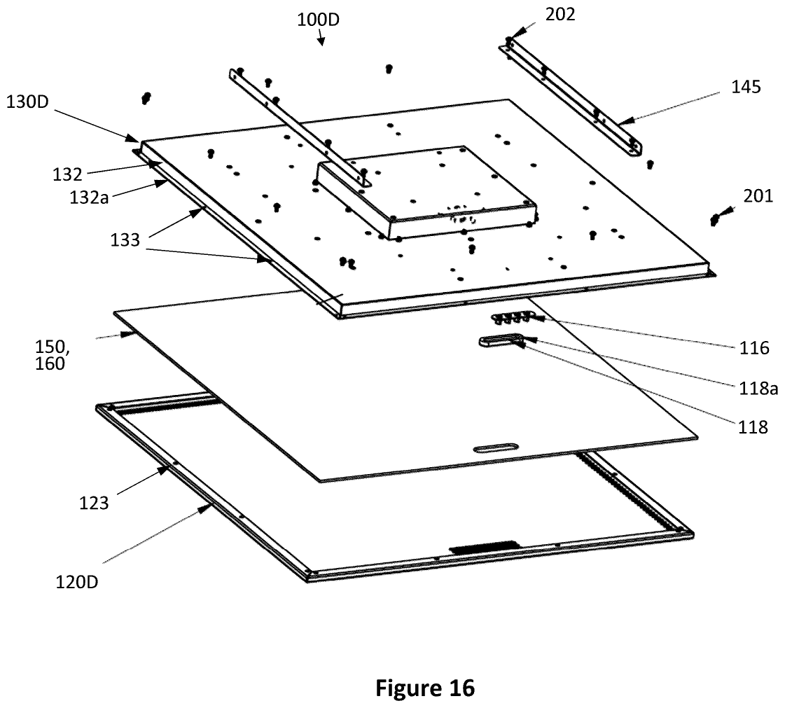

Referring now to FIG. 16, in an alternative embodiment, a ceiling-mountable microphone array enclosure 100D includes one or more sides 132 of the top panel 130D having one or more flanges 132a that extend substantially horizontally from the sides 132. The flanges 132a can be configured to lay substantially flat against the bottom room panel 120D along the border. Matching holes 133, 123, can be provided in the flanges of the top panel 130D and the border of the room panel 120D, respectively, to receive threaded screws 201 or other attachment mechanisms to connect the top panel 130D and the room panel 120D. Stiffeners 145 may also be connected to the top panel 130D using threaded screws 202 or other connection mechanisms.

As with other embodiments, a felt liner 150 and foam windscreen 160 can be sandwiched between the top and room panels 130D, 120D, respectively. Buttons, lights, and/or switches 116 can be arranged in a hole 118a of a mounting guide 118 so as to be accessible to or visible to a user in the room. The room panel 120D could be sized for any desired ceiling grid spacing.

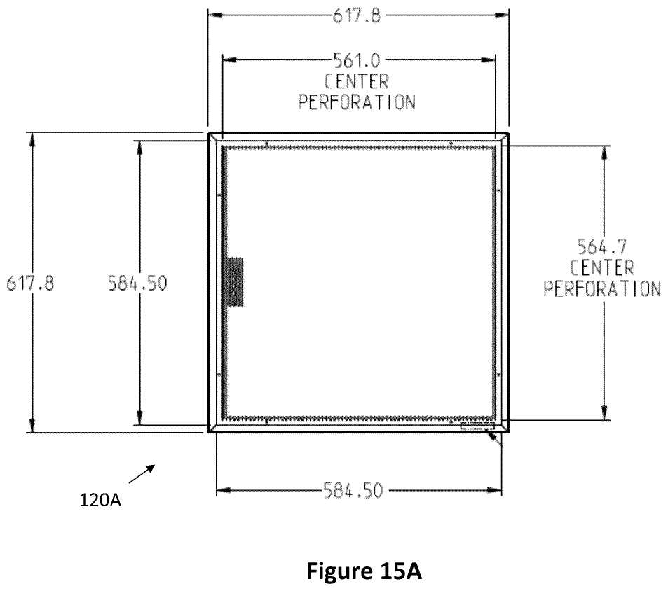

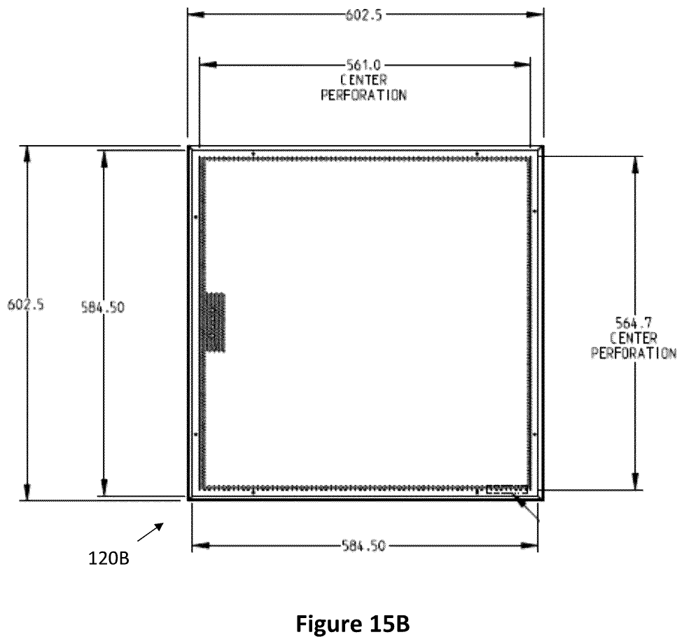

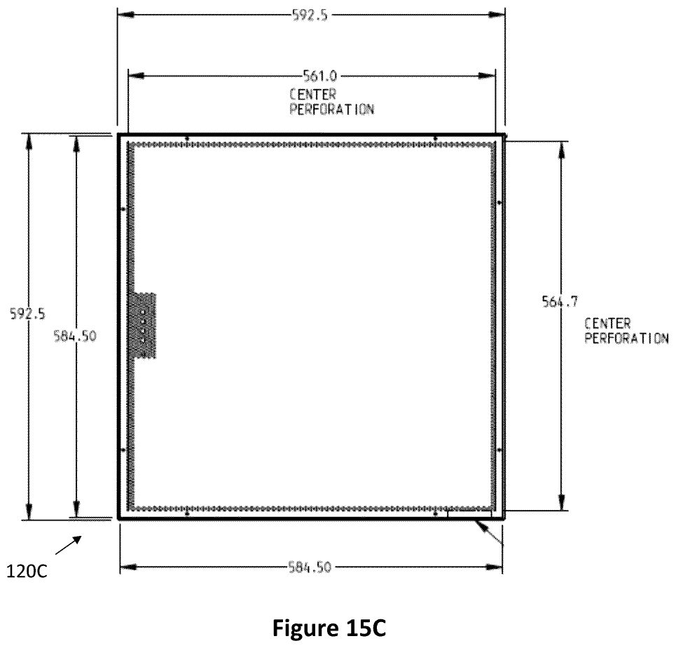

Referring now to FIGS. 1-16, drop ceiling grids typically have 24-inch grid spacing in the United States and 600 mm or 625 mm spacing in Europe and Asia. While conventional designs have required multiple mechanical components to be sized differently to accommodate the different grid spacings, according to further principles of the present inventive concepts, a top panel 130, 130A, 130D may be sized and shaped so as to be common to all of the various ceiling tile versions. Using this unique design, only the room panel size needs to be modified to accommodate the different drop ceiling grid spacings. Various sized room panels 120A, 120B, and 120C are illustrated in FIGS. 15A through 15B. The room panels 120, 120D could be any of these or other desired sizes.

For example, room panels 120A for larger ceiling grids could have a wider border 126 of solid material with the standoffs (or other connectors) 128 arranged further from the edges. Room panels 120C for smaller ceiling grids would have narrower borders 126 of solid material with the standoffs or other connectors 128 arranged closer to the edges. Regardless of model size, each of the room panels 120A, 120B, 120C would have the standoffs or other connectors 128 arranged in a position to communicate with corresponding connection features 138 of the top panel 130 so that regardless of which room panel 120A, 120B, 120C was selected, the top panel 130 could readily connect to the room panel 120. In this way, a single type and configuration of top panel 130 would be usable in connection with any of the variously-sized room panels 120A, 120B, 120C, thus reducing the number of different types of top panels 130 required.

Advantages obtained through these inventive principles include lower manufacturing costs and lower implementation costs to match color to room aesthetics. As explained above, this design enables faster assembly and disassembly to facilitate painting (or other aesthetic processes) because of a simpler connection between the room panel 120 and the top panel 130. Furthermore, increased sharing of mechanical parts between differently sized models leads to higher part volumes and lower cost per part compared to prior designs that required multiple parts to be different sizes to fit different ceiling grid spacing. Multiple different sizes of parts resulted in lower volumes for each part and therefore higher parts costs.

Although the structures, devices, methods, and systems have been described in accordance with various particular embodiments, one of ordinary skill in the art will readily recognize that many variations to the particular embodiments are possible, and any variations should therefore be considered to be within the spirit and scope disclosed herein. Accordingly, many modifications may be made by one of ordinary skill in the art without departing from the scope of the appended claims.

The claims following this written disclosure are hereby expressly incorporated into the present written disclosure, with each claim standing on its own as a separate embodiment. This disclosure includes all permutations of the independent claims with their dependent claims. Moreover, additional embodiments capable of derivation from the independent and dependent claims that follow are also expressly incorporated into the present written description. These additional embodiments are determined by replacing the dependency of a given dependent claim with the phrase “any of the claims beginning with claim [x] and ending with the claim that immediately precedes this one,” where the bracketed term “[x]” is replaced with the number of the most recently recited independent claim. For example, for the first claim set that begins with independent claim 1, claim 4 can depend from either of claims 1 and 3, with these separate dependencies yielding two distinct embodiments; claim 5 can depend from any one of claims 1, 3, or 4, with these separate dependencies yielding three distinct embodiments; claim 6 can depend from any one of claims 1, 3, 4, or 5, with these separate dependencies yielding four distinct embodiments; and so on.

Recitation in the claims of the term “first” with respect to a feature or element does not necessarily imply the existence of a second or additional such feature or element. Elements specifically recited in means-plus-function format, if any, are intended to be construed to cover the corresponding structure, material, or acts described herein and equivalents thereof in accordance with 35 U.S.C. § 112(f).

1. A ceiling-mountable microphone array system enclosure comprising:
a room-facing panel comprising a border of solid material arranged around a sound-permeable area having a plurality of sound permeable perforations, and a plurality of connection members arranged along the border of solid material of the room-facing panel; and
a top panel providing a cover for the enclosure, said top panel comprising a plurality of connection points to enable connections with the plurality of connection members of the room-facing panel;
wherein a plurality of microphone array system electronic components can be arranged within the microphone array system enclosure between the room panel and the top panel, said plurality of electronic components comprising a microphone array arranged in proximity to the sound permeable perforations.

2. The enclosure of claim 1, wherein:
the plurality of connection members arranged along an upper side of the border of solid material, the plurality of connection points arranged on the top panel, or both, comprise one or more standoffs; and
the standoffs support the top panel in such a way that the top panel does not directly contact the room-facing panel other than at the standoffs.

3. The enclosure of claim 2, wherein:
the standoffs are threaded standoffs; and
the connection points or connection members in the opposing one of the top panel or room-facing panel comprise screw holes arranged to communicate with the threaded standoffs to permit screws to be inserted therethrough to connect the top panel to the room-facing panel.

4. The enclosure of claim 1, wherein the top panel further comprises sides extending downward from the top panel, and one or more flanges extending from one or more of the sides of the top panel, wherein the flanges comprise one or more connection points arranged therein to match with connection members along the border of the room-facing panel.

5. The enclosure of claim 4, wherein the one or more flanges extend substantially horizontally and are configured to lay substantially flat against the border of the room-facing panel, and wherein the connection points in the flanges and connection members along the border of the room-facing panel comprise matching holes configured to receive threaded screws or other attachment mechanisms to connect the top panel to the room-facing panel.

6. The enclosure of claim 1, wherein the connection members on the room-facing panel comprise snap fit connectors configured to snap into or onto the connection points on the top panel.

7. The enclosure of claim 1, wherein the top panel further comprises an opening and connection points configured to receive and connect to a main board comprising electronic components of the microphone array system, and wherein the enclosure further comprises:
an IO panel configured to connect to the top panel and cover the main board.

8. The enclosure of claim 7, wherein the IO panel comprises one or more openings arranged through a top or side of the IO panel and configured to expose connector ports arranged on the main board.

9. The enclosure of claim 1, wherein the top panel comprises one or more sides bent downward from the upper member of top panel to provide sides to the enclosure.

10. The enclosure of claim 9, wherein a connection between the top panel and the room-facing panel leaves a gap between the sides of the top panel and the room-facing panel that permits airflow into and out of the enclosure.

11. A ceiling-mountable microphone array enclosure system comprising:
a plurality of differently-sized room-facing panels, each comprising a border of solid material arranged around a sound-permeable area, and a plurality of connection members arranged along the border of solid material of the room-facing panel; and
a top panel providing a cover for the enclosure, said top panel comprising a plurality of connection points to enable connections with the plurality of connection members of any of the differently-sized room-facing panels;
wherein a plurality of microphone array system electronic components can be arranged within the microphone array system enclosure between the room panel and the top panel, said plurality of electronic components comprising a microphone array arranged in proximity to the sound permeable area.

12. The enclosure system of claim 11, wherein the connection members comprise matching holes configured to receive screws or other connectors from the connection points of the top panel.

13. The enclosure system of claim 11, wherein the top panel comprises one or more sides extending downward toward the room-facing panel.

14. The enclosure system of claim 13, wherein one or more of the sides has a flange that extends substantially horizontally from the side and is configured to lay substantially flat against the border of the room-facing panel.

15. The enclosure system of claim 11, wherein the plurality of differently-sized room-facing panels comprises a panel for two or more of a 24-inch ceiling grid, a 600 mm ceiling grid, and a 625 mm ceiling grid.

16. The enclosure system of claim 11, wherein the connection members comprise standoffs that connect to the connection points of the top panel.

17. An enclosure for a ceiling mountable microphone array system, the enclosure comprising:
a top panel having a substantially flat upper panel with one or more sides bent downward from the upper panel to form sides for the enclosure;
a room panel comprising a substantially flat bottom panel with a number of sound permeable perforations arranged in a central area of the lower panel and a border of solid material arranged around an outside perimeter of the lower panel; and
a plurality of connection members arranged along the border of solid material to connect the bottom panel to the top panel.

18. The enclosure according to claim 17, wherein one or more of the sides comprise one or more substantially horizontal flanges configured to lay substantially flat against the border, and wherein the top panel is connected to the bottom panel at connection points in the flanges that correspond with connection members of the border.

19. The enclosure according to claim 17, further comprising standoffs, wherein the standoffs are threaded standoffs and are configured to receive screws through screw holes arranged in an opposing one of the top or bottom panel to connect the top panel to the bottom panel.

20. The enclosure according to claim 19, wherein the standoffs comprise snap-fit connectors configured to connect with corresponding connection features in the opposing one of the top or bottom panel.
